(19) United States
(12) Patent Application Publication
(10) Pub. No.: US 2004/0038179 A1
(43) Pub. Date: Feb. 26, 2004

(54) Healing abutment

(76) Inventors: Ajay Kumar, Palmdale, CA (US); Grant Bullis, Corona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/314,895

(22) Filed: Dec. 9, 2002

Related U.S. Application Data
(60) Provisional application No. 60/339,127, filed on Dec. 7, 2001.

(51) Int. Cl. A61C 8/00

(52) U.S. Cl. 433/173

(57) ABSTRACT

A healing abutment is provided shaping a patient's gum tissue. In one embodiment, the healing abutment includes a snapping portion that snaps into a corresponding recess that is provided in a dental implant. In another embodiment, the healing abutment includes a snapping portion that forms a friction fit with a socket of the dental implant.

### PRIORITY INFORMATION

This application claims the priority benefit under 35 U.S.C. § 119(e) of Provisional Application No. 60/339,127 filed Dec. 7, 2001.

### BACKGROUND OF THE INVENTION

1. Field of the Invention

This invention relates to implant dentistry. More particularly, the invention relates to a healing abutment adapted to be received upon a dental implant.

2. Description of the Related Art

Implant dentistry involves the restoration of one or more teeth in a patient's mouth using artificial components. Such artificial components typically include a dental implant and a prosthetic tooth and/or a final abutment that is secured to the dental implant. The process for restoring a tooth can be carried out in three stages.

Stage I involves implanting the dental implant into the bone of a patient's jaw. The oral surgeon first accesses the patient's jawbone through the patient's gum tissue and removes any remains of the tooth to be replaced. Next, the specific site in the patient's jaw where the implant will be anchored is widened by drilling and/or reaming to accommodate the width of the dental implant to be implanted. Then, the dental implant is inserted into the hole in the jawbone, typically by screwing, although other techniques are known for introducing the implant in the jawbone.

The implant itself is typically fabricated from pure titanium or a titanium alloy. Such materials are known to produce osseointegration of the fixture with the patient's jawbone. The dental implant fixture also typically includes a hollow threaded bore through at least a portion of its body and extending out through its proximal end which is exposed through the crestal bone for receiving and supporting the final tooth prosthesis and/or various intermediate components or attachments.

After the implant is initially installed in the jawbone, a cover screw is secured over the exposed proximal end in order to seal the internal bore. The patient's gums are then sutured over the implant to allow the implant site to heal and to allow desired osseointegration to occur during a first healing period. Complete osseointegration typically takes anywhere from four to ten months.

During stage II, the surgeon reaccesses the implant fixture by making an incision through the patient's gum tissues. The cover screw is then removed, exposing the proximal end of the implant. The interior of the implant is thoroughly cleaned and dried. The surgeon then attaches a temporary healing abutment or a final abutment to the implant. Typically, the healing or final abutment includes a threaded post, which is screwed directly into the hollow threaded bore of the implant. The healing abutment is used to control the healing and growth of the patient's gum tissue during a second healing period that occurs between State II and Stage m surgery.

To accurately record the position, orientation and the shape of the final abutment, the surgeon can take a mold or impression of the patient's mouth during Stage II. The impression is used to create a plaster model or analogue of the mouth and the abutment and provides the information needed to fabricate the prosthetic replacement tooth and any required intermediate prosthetic components.

Stage III involves fabricating and placement of a cosmetic tooth prosthesis to the implant fixture. The plaster analogue provides laboratory technicians with a model of the patient's mouth and the final abutments. Based on this model, the technician constructs a final restoration. The final step in the restorative process is attaching the final restoration to the abutment.

### SUMMARY OF THE INVENTION

The dental components used in implant dentistry are typically quite small and therefore are relatively difficult to hold and manipulate. For example, Applicants have discovered that it is particularly difficult to attach the temporary healing abutment to the implant during stage II surgery, which may result in the temporary healing abutment being dropped into the patients' mouth. Therefore, a need exists for an improved healing abutment that is more easily attached to a dental implant.

In accordance with one aspect, the present invention provides a healing abutment for attaching to a dental implant, which has an inner cavity defined by an inner wall. The healing abutment has proximal end and a distal end. The distal end includes first complementary structure that is sized and dimensioned to apply a releasable latent lateral retention force against the inner wall of the implant. The proximal end is configured to shape the patient's gum tissue.

In accordance with another aspect, the present invention provides a healing abutment for attaching to a dental implant, which has an inner cavity with a recess. The healing abutment has a proximal end and a distal end. The distal end includes a first complementary structure that is sized and dimensioned to engage the recess in a snap fit. The proximal end is configured to shape the patient's gum tissue.

In accordance with another aspect, the present invention provides a method of securing a healing abutment to an implant installed in a patient's jawbone. The method comprises inserting a distal end of the healing abutment into a coronal opening of the implant until the distal end engages and secures the healing abutment to the implant in a friction fit, inserting a bolt into a bore of the healing abutment, and threading the bolt into a threaded chamber of the implant to secure the healing abutment to the implant.

In accordance with another embodiment, the present invention provides a method of securing a healing abutment to an implant installed in a patient's jawbone. The method includes inserting a distal end of the healing abutment into a coronal opening of the implant until said distal end engages the implant in a snap fit, inserting a bolt into a bore of the healing abutment, and threading the bolt into a threaded chamber of the implant to secure the healing abutment to the implant.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1A is a side view of a dental implant having certain features and advantages according to the present invention;

FIG. 1B is a top plan view of the dental implant of FIG. 1A;

FIG. 1C is a cross-sectional view of a proximal portion of the dental implant of FIG. 1A;

FIG. 1D is a side view of a modified dental implant without threads.

FIG. 2A is a side view of a healing abutment having certain features and advantages according to the present invention;

FIG. 2B is a bottom plan view of the healing abutment of FIG. 2A;

FIG. 2C is a top plan view of the healing abutment of FIG. 2A;

FIG. 2D is a cross-sectional view taken through line D-D of FIG. 2A;

FIG. 2E is a perspective view of the healing abutment of FIG. 2A;

FIG. 3A is a side view of a modified embodiment of a dental implant having certain features and advantages according to the present invention;

FIG. 3B is a cross-sectional view taken through line 3B-3B of FIG. 3A; and

FIG. 3C is a top plan view of part of the dental implant of FIG. 3A.

### DETAILED DESCRIPTION OF THE PREFERRED EMBODIMENT

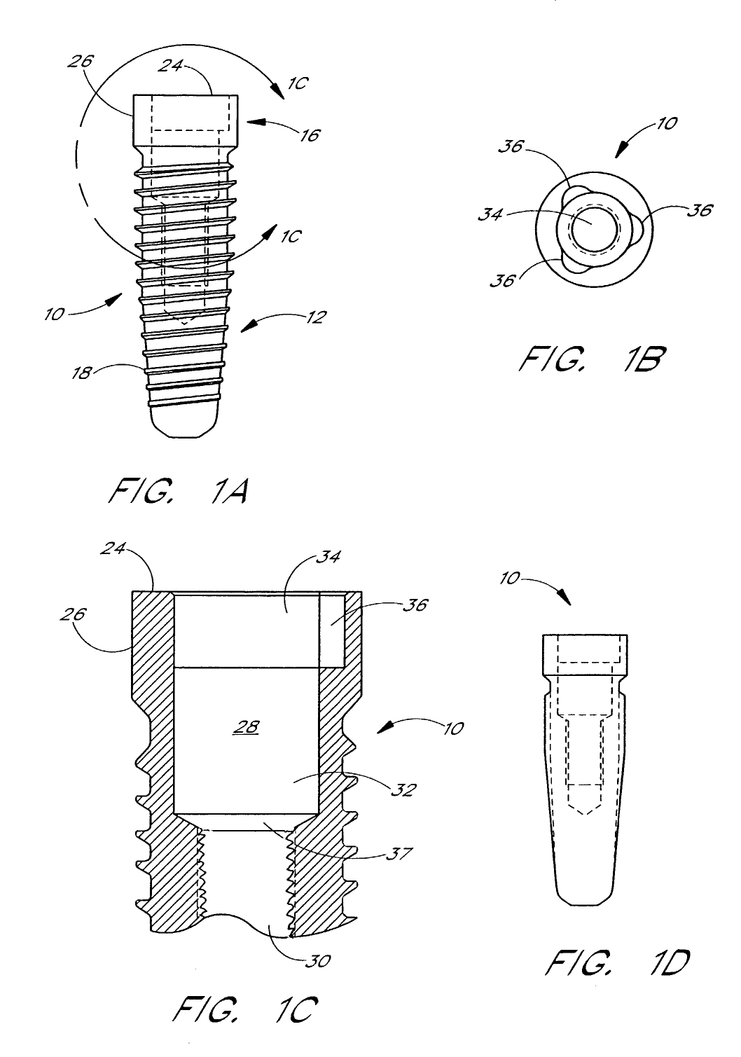

With initial referenced to FIGS. 1A-1C, one embodiment of a dental implant 10 will be described. The implant 10 is preferably sized and dimensioned to receive and support one or more dental attachments or components. In particular, the dental implant 10 is sized and dimensioned to support a healing abutment, which will be described in detail below. The implant 10 is preferably made of a dental grade titanium alloy, although other suitable materials can also be used.

As best seen in FIG. 1A, the implant 10 includes a body portion 12 and a collar 16. The body portion 12 is preferably tapered and includes threads 18 that mate to a preformed threaded hole or osteotomy formed in the patient's jawbone (not shown). However, it should be appreciated that the body portion 12 can also be configured so as to be self-tapping. It should also be appreciated that although the illustrated body portion 12 is tapered or conical, the body portion 12 can be substantially cylindrical. Finally, it should be appreciated that the body portion 12 can be partially or completely unthreaded, as shown in FIG. 1D, if the surgeon prefers to use an unthreaded implant 10.

The collar 16 of the implant is substantially cylindrical and has a top surface 24 that in the illustrated embodiment is substantially planar and transverse to the longitudinal axis of the implant 10. In modified embodiments, the top surface 24 may be contoured or scalloped so as to match the contours of the patients bone or soft tissue such as in the implants described in U.S. Pat. No. 6,174,167, which is hereby incorporated by reference herein. The collar 16 is defined in part by a an external axial side wall 26 that, in the preferred embodiment, is approximately 2 millimeters in axial length.

As best seen in FIG. 1C, the implant 10 also includes an internal socket 28. The internal socket 28 preferably includes a threaded chamber 30, an anti-rotation chamber 34, and optimally a receiving chamber 32.

With reference to FIGS. 1B and 1C, the anti-rotation or indexing chamber 34 has a central portion having a substantially cylindrical shape. The anti-rotation chamber 34 further includes one or more radially extending rotational engagement portions each comprising a channel or lobe 36 extending from the top surface 24 to the bottom of the indexing chamber 34. In the illustrated embodiment, three engagement portions 36 are provided, each having a substantially radially inwardly directed concavity, such as a half circular shape. As best seen in FIG. 1B, the channels 36 are situated and evenly centered around the perimeter of the indexing region 34. Each channel 36 may be spaced 120 degrees apart from each other channel 36. The anti-rotation chamber 34 is designed to mate with a corresponding anti-rotation region formed on various mating components, such as, for example, a final abutment. The anti-rotation chamber 34 primarily serves to prevent relative rotation between the mating component and the implant 10.

It should be appreciated that the anti-rotation chamber 36 can be formed into a wide variety of other suitable shapes that may be used with efficacy, giving due consideration to the goals of providing anti-rotation of mating components. For example, the anti-rotation chamber 34 could comprise one or more radially inwardly or outwardly extending splines or recesses, flats, polygonal configurations and other anti-rotation complementary surface structures. In addition, an anti-rotational structure such as a hexagonal recess or protrusion may be situated on the top surface 24 of the implant 10. Nevertheless, the illustrated arrangement appears to provide clinical efficacy, ease of use and also minimizes stress concentrations within the anti-rotation chamber 34.

The post-receiving or alignment chamber 32 lies between the anti-rotation chamber 34 and the threaded chamber 30. The post-receiving chamber 32 may have a diameter that is less than the diameter of the anti-rotation chamber 36. The post-receiving receiving chamber 32 may include a chamfered region 37, which is adjacent the threaded region 30. The receiving chamber 32 is sized and dimensioned to receive a post that is attached to a mating dental component, such as, for example, a final abutment. The post and the post-receiving chamber 32 provide lateral support, which prevents the mating component from tipping off the implant. However, it should be appreciated that several advantages of the present invention can be achieved with an implant 10 formed without the post-receiving chamber 32.

The threaded chamber 30 lies below the post-receiving chamber 32. The threaded chamber 30 is threaded and has a diameter that may be less than the post-receiving chamber 32. The threaded chamber 30 is configured to receive a bolt (not shown), which can be used to secure a mating component to the implant 10.

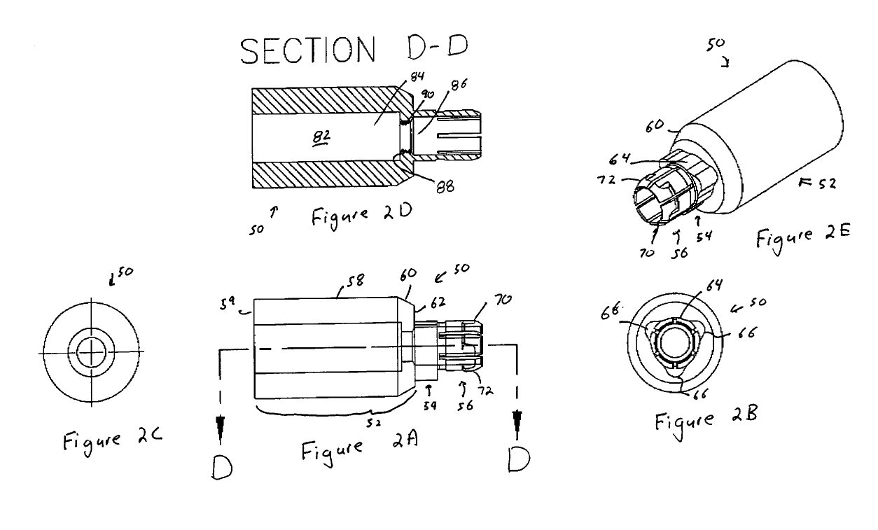

FIGS. 2A-E illustrate a healing abutment 50 having features and advantages in according to the present invention. As mentioned above, the healing abutment 50 is typically used during the second healing period to shape the patient's gums.

As best seen in FIGS. 2A and 2E, the healing abutment 50 includes an upper (proximal) portion 52, an anti-rotation portion 54, and a snapping portion 56. In the illustrated embodiment, the upper region 52 includes a cylindrical portion 58, which is substantially smooth and has a top surface 59 that is substantially planar in a transverse axis. A tapered shoulder 60 lies below the cylindrical portion 58 and above the indexing region 54. The upper region 52 is configured to shape the patient's gums during the second healing period. As such, the shape of the upper region 52 can be modified as deemed appropriate to achieve the desired shape of the patient's gums. For example, in the illustrated arrangement, the upper region 52 has a generally round external cross-section (see FIG. 2C). In a modified arraignment, the upper region 52 can have a non-round cross-section, which can match or closely correspond to the cross-section of the final restoration.

A bottom surface 62 lies at the distal end of the shoulder 60. The bottom surface 62 is substantially transverse to the longitudinal axis and has an outside diameter approximately equal to the diameter of the top surface 24 of the implant 10. Extending from the bottom surface 62 is the anti-rotation portion 54, which is configured to fit within the anti-rotation chamber 34 of the implant 10. Accordingly, as best seen in FIGS. 2B and 2E, the anti-rotation portion 54 includes a substantially cylindrical portion 64. The interlock area 38 also includes protrusions 66, which are configured to rotationally engage the channels 36 of the implant 10. Accordingly, in the illustrated embodiment, the three protrusions 66 are arranged around the perimeter of the anti-rotation portion 54 at approximately 120 degrees. Like the anti-rotation chamber 34 of the implant 10, the anti-rotation portion 54 may be formed into a wide variety of other shapes that may be used with efficacy, giving due consideration to the goals of providing repeatable indexing and anti-rotation of mating components. For example, the anti-rotation chamber 34 and anti-rotation portion 54 could comprise any of a variety of complementary surface structures such as a hexagonal recess or protrusion on the implant 10 or the healing abutment 50.

Below the anti-rotation portion 54 is the snapping portion 56. The illustrated snapping portion 56 comprises of a plurality of prongs or lever arms 70. Each prong 70 preferably includes a rounded protrusion 72 although in modified embodiments the prong can be formed without the rounded protrusion 72. The prongs 70 are configured such that, when the snapping portion 56 is inserted into the receiving chamber 32 of the implant 10, the protrusions 72 apply a lateral force against the receiving chamber 32 sufficient to secure the healing abutment 50 to the implant 10. Specifically, the lateral force is great enough to prevent the healing abutment 50 from falling out of the implant 10 due to gravity when the socket 28 opens in a downward direction. As such, the protrusions 72 have an outer diameter in a relaxed configuration that is slightly larger than the inner diameter of receiving chamber 32.

Any of a variety of complementary surface structures can be provided, to create a releasable retention force between the implant 10 or 100 (discussed below) and healing abutment 50 in accordance with the present invention. In the illustrated embodiment, the rounded or tapered leading edge 74 on each protrusion 72 cooperates with the tapered chamfered region 37 to force the protrusion radially inwardly, thereby creating a radially outwardly directed bias to produce a friction or mechanical interference fit retention force. This is facilitated by positioning each protrusion 72 on a prong 70 which includes a lever arm 76 to produce the lateral spring bias. The tubular snapping portion may be provided with a plurality of lever arms 76 by creating a plurality of axially extending slots 78 to isolate the lever arms 76.

The protrusion 72 frictionally engages the interior surface of the implant illustrated in FIGS. 1A-1C. Friction may be enhanced in any of a variety of manners, such as by increasing the cross sectional area of, or shortening the axial length of, the lever arms 76. In the illustrated embodiment, the lever arm has an axial length of about 2.5 millimeters, a radial thickness of about 0.5 millimeters, and a circumferential width of about 1.25 millimeters. Alternatively, the interior surface of the implant in the receiving chamber 32 may be provided with any of a variety of friction enhancing surface structures, such as roughening, or the provision of an adhesive.

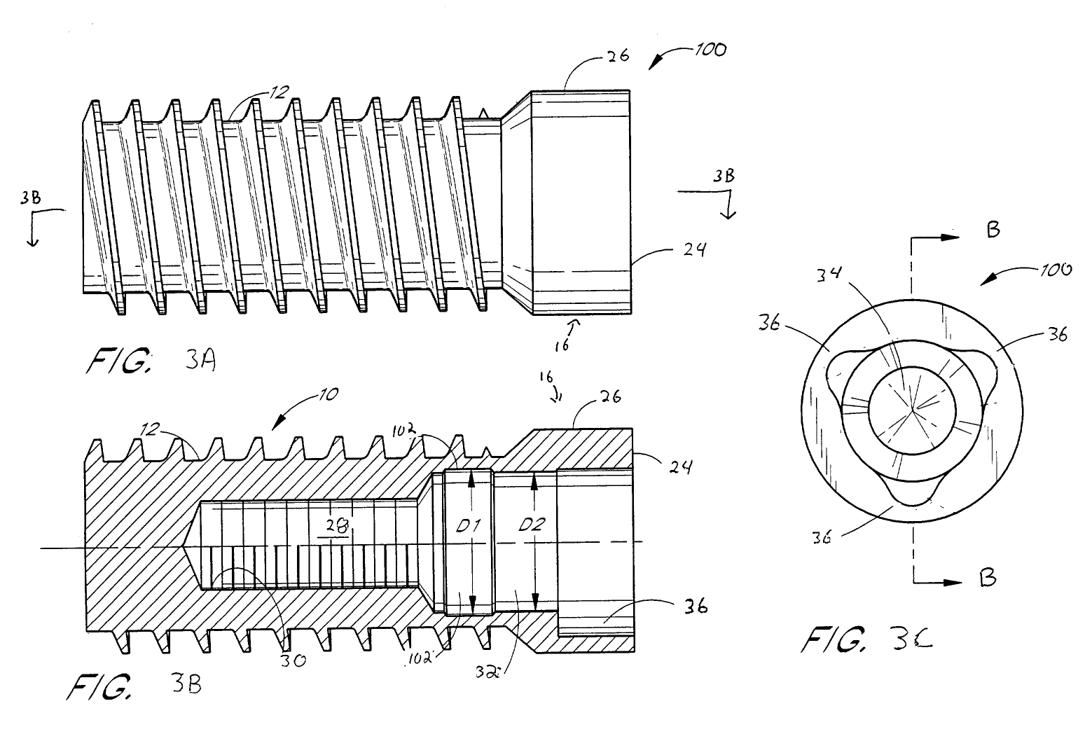

Although six prongs 70 with protrusions 72 thereon are illustrated, this number may be varied to produce the desired retention force and simplify manufacturing. For example, as few as one or two protrusions may be sufficient, particularly in an interference fit construction such as that achieved with the structure shown in FIG. 3B, where the protrusion snap fits into a radially outwardly extending recess within the implant. Six or more may alternatively be used.

Any of the foregoing relationships can be reversed, between the implant 10 or 100 and the healing abutment, as will be apparent to those of skill in the art in view of the disclosure herein. For example, a radially inwardly directed bias on a component of the implant may be configured to snap fit within a radially inwardly extending recess or friction surface on the healing abutment. In general, the two components are provided with first and second complementary surface structures to permit a releasable engagement, having a retention force sufficient to retain the abutment 50 as is helpful during the procedure, but which can be readily overcome by forceably pulling the abutment 50 from the implant 10 or 100 at the appropriate time using dental pliers or other conventional dental hand tool without disrupting the osseointegration of the implant or causing discomfort to the patient.

As best seen in FIG. 2D, an inner bore 82 extends through the center of the abutment 50. The inner bore 82 is preferably divided into a first and second region 84, 86. The first region 84 has a diameter that is slightly larger than the diameter of the second region 86 Accordingly, a seat 88 is formed between the first and second regions 84, 86. The seat 88 supports a bolt (not shown), the use of which will be described below. The second region 86 preferably includes internal capture threads 90 that may be double threaded.

As mentioned above, the healing abutment 50 is typically attached to the dental implant during Stage II. To attach the healing abutment 50 to the implant 10 during stage II, the surgeon places the healing abutment 50 over the implant 10 and pushes the abutment 50 into the implant 10. As mentioned above, the protrusion 70 have a larger diameter than the inner diameter of the receiving chamber 32. Accordingly, the snapping portion 56 of the abutment 50 is compressed as it passes into the receiving chamber 32. As such, the protrusions 72 apply a latent lateral force against the walls of the receiving chamber 34. This latent force increases the friction force between the protrusions 72 and the receiving chamber. This friction force preferably is strong enough to prevent the healing abutment 50 from falling out of the implant 10 when the implant 10 is in an inverted position. In this manner, the dental surgeon can temporarily secure the healing abutment 50. After the healing abutment 50 is inserted into the implant 10, the surgeon can more securely attach the abutment 50 to the implant with a bolt that extends through the bore 82 and into the threaded chamber 30 of the implant. The snapping portion 56 of the abutment 50 advantageously holds the abutment 50 in place on the implant 50 while the surgeon reaches for the bolt, aligns the bolt with the bore 82 and inserts the bolt into the threaded chamber 30.

FIGS. 3A-C illustrated a modified dental implant 100 that can be used with the healing abutment 50 described above. Like numbers are used to refer to parts similar to those of FIGS. 1A-C. In the embodiment of FIGS. 3A-C, the receiving chamber 32 includes a recessed portion 102 that has a inner diameter D1 that is slightly larger than the inner diameter D2 of the receiving chamber 32. This feature can readily be incorporated into the implant of FIGS. 1A-1C. In this arrangement, once the prongs 70 reach the recessed portion 102, they expand forming a snap fit between the abutment 50 and the implant 100. Preferably, the prongs 70 provide an audible feedback when the snap fit is formed. Such audible feedback advantageously indicates to the surgeon that the abutment 50 is properly seated on the implant 10. After the snap fit is formed, the abutment 50 is preferably secured to the implant 10 with a bolt as describe above. It should be appreciated that once the snap fit is formed the prongs 70 can be configured such that they do not apply a latent lateral force to the walls of the receiving chamber 32.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combination or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A healing abutment for attaching to a dental implant, which has an inner socket defined by an inner wall, the healing abutment having a proximal end and a distal end, said distal end including a first complementary surface structure that is sized and dimensioned to create a releasable retention force with the inner wall of the implant, the proximal end being configured to shape the patient's gum tissue.

2. A healing abutment as in claim 1, wherein the first complementary surface structure comprises at least one lever arm.

3. A healing abutment as in claim 2, wherein the lever arm includes a protrusion.

4. A healing abutment as in claim 4, wherein the protrusion includes tapered leading edge.

5. A healing abutment as in claim 1, comprising an anti-rotation portion.

6. A healing abutment as in claim 5, wherein the anti-rotation portion comprises a substantially cylindrical portion and three protrusions that are arranged approximately 120 degrees about a perimeter of the substantially cylindrical portion.

7. A healing abutment as in claim 1, further comprising an inner bore, which extends from the distal end to the proximal end of the healing abutment.

8. A healing abutment as in claim 7, wherein the inner bore includes seat for supporting a bolt configured to extend through the healing abutment and into the inner socket of the dental implant.

9. A healing abutment for attaching to a dental implant, which has an inner socket with a recess, the healing abutment having a proximal end and a distal end, said distal end including a first complementary surface that is sized and dimensioned to engage the recess in a snap fit, the proximal end being configured to shape the patient's gum tissue.

10. A healing abutment as in claim 9, wherein the first complementary surface structure comprises at least one lever arm.

11. A healing abutment as in claim 10, wherein the at least one lever arm includes a protrusion.

12. A healing abutment as in claim 11, wherein the protrusion includes tapered leading edge.

13. A healing abutment as in claim 10, comprising an anti-rotation portion.

14. A healing abutment as in claim 13, wherein the anti-rotation portion comprises a substantially cylindrical portion and three protrusions that are arranged approximately 120 degrees about a perimeter of the substantially cylindrical portion.

15. A healing abutment as in claim 9, further comprising an inner bore, which extends from the distal end to the proximal end of the healing abutment.

16. A healing abutment as in claim 15, wherein the inner bore includes seat for supporting a bolt configured to extend through the healing abutment and into the inner socket of the dental implant.

17. A dental implant system comprising:
a dental implant comprising a body portion and a top surface, the implant further comprising an inner socket defined by an inner wall with an opening located at the top surface;
a healing abutment for attaching to the dental implant comprising a proximal end and a distal end, the proximal end being configured to shape the patient's gum tissue; and
complimentary surface structures on the dental implant and the distal end of the healing abutment to create a releasable retention force between the dental implant and the healing abutment.

18. A dental implant system as in claim 17, wherein the complimentary surface structures comprise the inner wall of the inner socket and a first complementary surface structure on the distal end of the healing abutment, the first complementary surface structure being sized and dimensioned to apply a lateral force against the inner wall

19. A dental implant system as in claim 17, wherein the complimentary surface structures comprises a recess formed on the inner wall of the inner socket and a first complementary surface structure on the distal end of the healing abutment, the first complementary surface structure being sized and dimensioned to engage the recess in a snap fit.

20. A dental system as in claim 17, wherein the inner socket of the dental implant includes an anti-rotation chamber and the healing abutment includes a corresponding anti-rotation portion that is sized and dimensioned to engage the anti-rotation chamber.

21. A dental implant system as in claim 20, wherein the anti-rotation portion comprises a substantially cylindrical portion and three protrusions that are arranged approximately 120 degrees about a perimeter of the substantially cylindrical portion.

22. A dental implant system as in claim 17, wherein the complementary surface structures comprises at least one lever arm positioned on the distal end of the healing abutment.

23. A dental implant system as in claim 22, wherein the at least one lever arm includes a protrusion.

24. A dental implant system as in claim 23, wherein the protrusion includes tapered leading edge.

25. A dental implant system as in claim 17, wherein the healing abutment includes an inner bore that extends from the distal end to the proximal end of the healing abutment, the inner bore including a seat.

26. A dental system as in claim 25, comprising a bolt having a proximal end configured to engage the seat and a distal end configured to engage a threaded portion of the internal socket so as to secure the healing abutment to the dental implant.

27. A method of securing a healing abutment to an implant installed in a patient's jawbone, comprising:
inserting a distal end of the healing abutment into a coronal opening of the implant until said distal end releasably engages and secures the healing abutment to the implant;
inserting a bolt into a bore of the healing abutment, and
threading the bolt into a threaded chamber of the implant to secure the healing abutment to the implant.

28. The method of claim 27, wherein the distal end of the healing abutment realeasably engages the implant in a friction fit.

29. The method of claim 27, wherein the distal end of the healing abutment realeasably engages the implant in a snap fit.

30. The method of claim 27, wherein the distal end of the healing abutment realeasably engages the implant in an interference fit.
